(19) United States
(12) Patent Application Publication
(10) Pub. No.: US 2013/0277918 A1
(43) Pub. Date: Oct. 24, 2013

(54) High Temperature Device Shaft Brush Seal Assembly, Brush Seal, And Mounting Arrangement

(71) Applicants: Patrick Fitzgerald, Richmond, VA (US); David D. Stein, Brookfield, WI (US)

(72) Inventors: Patrick Fitzgerald, Richmond, VA (US); David D. Stein, Brookfield, WI (US)

(73) Assignee: Sealeze, A Unit Of Jason Incorporated, Richmond, VA (US)

(21) Appl. No.: 13/993,816

(22) PCT Filed: Dec. 13, 2011
(86) PCT No.: PCT/US11/64748

§ 371 Date: Jun. 13, 2013

Related U.S. Application Data
(60) Provisional application No. 61/422,446, filed on Dec. 13, 2010.

(51) Int. Cl. F16J 15/32

(52) U.S. Cl. CPC F16J 15/3232
USPC 277/355

(57) ABSTRACT

A shaft seal assembly externally mounted to a high temperature device, such as a gas or steam turbine, having a plurality of rotary shaft sealing brush seals that includes at least one brush seal of wear-compensating construction that possesses a suitably high linear coefficient of expansion so it viscoelestically creeps over time compensating for brush seal wear. In one embodiment, a brush seal closest to the device is formed of an electrically conductive material that electrically grounds a rotary shaft of the device during shaft rotation and at least one other brush seal is formed of filaments of polymeric material, such as heat stabilized nylon, of wear compensating construction. In one preferred embodiment, the filaments of the inner brush seal are made of a self-lubricating metallic or bearing material and at least one other brush seal is formed of an intumescing material that can be of polymeric composition.

### FIELD

The present invention relates to a high temperature device seal assembly and more particularly to a brush seal assembly and mounting arrangement for external mounting providing improved sealing.

### BACKGROUND

Many types of machinery, such as steam turbines and gas turbines, employ a rotating shaft that conveys rotary power to another component, such as to drive or power that component. The shaft extends outwardly of a housing in which a pressure differential exists with the environment outside the housing. Where such a pressure differential exists, it is desired to minimize pressure loss so as to maximize the pressure differential. By maximizing pressure differential by preventing pressure loss, efficiency is increased.

For example, pressure loss in steam and gas turbines used to generate electricity reduce their efficiency, increase their operating cost, thereby decreasing profitability. Since equipment replacement costs are high, many older steam and gas turbines remain in operation that suffer from efficiency and profit robbing pressure leakage unless frequently maintained. Many older steam turbines employ gland seals within the housing to try and prevent leakage. Unfortunately, these gland seals do not work particularly well and tend to require frequent maintenance to keep them sealing properly. This requires turbine downtime, which is not only costly, it requires the turbine to be taken off-line costing even more money.

It is not unusual for seal maintenance to be delayed because turbine operators are trying to make a judgment call between the cost of turbine downtime required for maintenance and the costs associated with loss of efficiency resulting from poor sealing. Unfortunately, efficiency losses resulting from poor sealing also cost money. For example, a 400 megawatt steam turbine suffering from a 1½% leakage loss can lose as much as $600 per day in lost electrical power generating capacity. When you add this up over the course of a year in a power generating station having several steam turbines, the losses can be add up to millions of dollars.

Even where leakage is minimal, pressure or vacuum fluctuations from lower level leakage, which tend to occur at less than full load operation, can lead to excessive condensing pump vibration. Over time, vacuum or pressure fluctuation induced vibration can undesirably lead to premature condensing pump bearing failure.

What is needed is a sealing arrangement that provides a better seal for high temperature devices that operate under a pressure differential relative to ambient and which does so for a longer period of time. What is also needed is a sealing arrangement that can be externally retrofitted to existing steam and gas turbines.

### SUMMARY

The present invention is directed to a shaft seal assembly externally mounted to a high temperature device, such as a gas or steam turbine, having a plurality of annular rotary shaft sealing brush seals that includes at least one brush seal of wear-compensating construction that possesses a suitably high linear coefficient of expansion so it viscoelestically creeps over time compensating for brush wear. In one embodiment, a brush seal closest to the device is formed of an electrically conductive metallic material, such a self-lubricating bearing material, that electrically grounds a rotary shaft of the device during shaft rotation and at least one other brush seal is formed of filaments of wear compensating construction that preferably is a polymeric material, such as heat stabilized nylon. In one preferred embodiment, the filaments of the innermost brush are made of a self-lubricating metallic or bearing material and at least one other brush is formed of an intumescing material that can be of polymeric composition whose filaments can be supported by the innermost brush. In one preferred embodiment, the wear compensating filament material of at least one of the brushes is made of a polymeric material having linear coefficient of expansion of at least 60 10⁻⁶ m/m per degree Kelvin producing an externally mounted shaft seal assembly of economical construction.

### DRAWING DESCRIPTION

One or more preferred exemplary embodiments of the invention are illustrated in the accompanying drawings in which like reference numerals represent like parts throughout and in which:

FIG. 1 is a fragmentary perspective view of a turbine depicting an externally mounted brush seal assembly that seals against a rotary shaft of the turbine;

FIG. 2 is a fragmentary transverse cross sectional view of rotary shaft of the turbine showing the brush seal assembly sealing thereon;

FIG. 3 is an enlarged fragmentary longitudinal cross sectional view of an embodiment of the brush seal assembly depicting a plurality of brushes of the assembly in sealing contact with an outer surface of the rotary shaft;

FIG. 4 is a side elevation view of a segment of the brush seal assembly illustrating an annular brush holder ring removably holding an annular sealing brush;

FIG. 5 is a side elevation view of the segment of the brush seal assembly shown in FIG. 4 with part of the annular brush holder ring cutaway to illustrate the holder removably holding a portion of a brush;

FIG. 6 is a second side elevation view of the segment of the brush seal assembly shown in FIG. 4 with another part of the annular brush holder ring cutaway to better illustrate the brush seal held by the holder ring;

FIG. 7 is an enlarged fragmentary perspective end view of a portion of the brush holder ring attached to a mounting ring and removably holding a brush;

FIG. 8 is an enlarged fragmentary perspective end view of a portion of the brush holder ring with the brush removed; and

FIG. 9 is an enlarged cross-sectional view of the brush holder ring with the brush removed.

Before explaining one or more embodiments of the invention in detail, it is to be understood that the invention is not limited in its application to the details of construction and the arrangement of the components set forth in the following description or illustrated in the drawings. The invention is capable of other embodiments, which can be practiced or carried out in various ways. Also, it is to be understood that the phraseology and terminology employed herein is for the purpose of description and should not be regarded as limiting.

### DETAILED DESCRIPTION

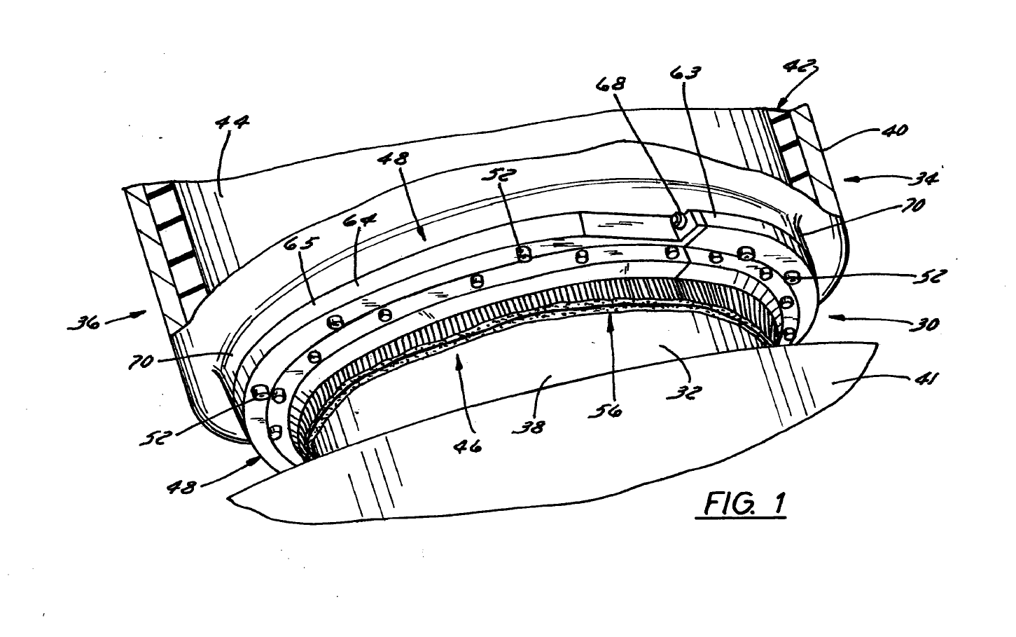

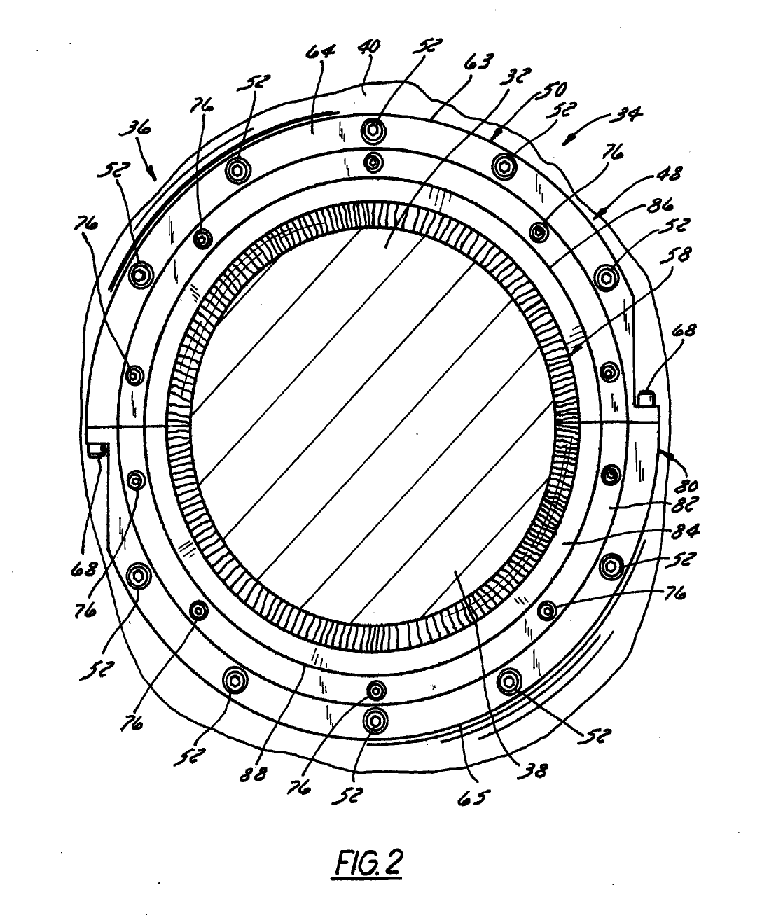

FIGS. 1 and 2 illustrate a preferred embodiment of a brush seal assembly 30 for a high temperature rotary sealing application, such as a rotary shaft 32 of a high temperature device 34, where the seal assembly 30 is used to help maintain a pressure differential between the inside and outside of the device 34. One embodiment of a high temperature device 34 is a turbine 36 that can be a steam turbine or gas turbine. Where the device 34 is a turbine 36, the rotary shaft 32 is a turbine shaft 38 that extends outwardly from a housing 40 of the turbine 36 inside of which exists a pressure differential relative to the exterior of the turbine 36.

For example, with continued reference to FIGS. 1 and 2, in at least one known steam turbine used in electrical power generation, the pressure and the velocity of steam within the turbine 36 creates a pressure differential within the turbine housing 40 such that the pressure outside the housing 40 is greater than the pressure inside the housing 40 in the vicinity of the turbine shaft 38. To help prevent leakage, the turbine 36 has a first sealing arrangement 42, shown schematically or generically in FIG. 1, inside the turbine housing 40, such as a conventional gland sealing arrangement 44 employing a plurality of gland seals (not shown) that seal against part of the turbine shaft 38 disposed within the housing 40.

As a result of being located within the turbine housing 40, servicing of the gland sealing arrangement 44 typically requires the turbine 36 to be shut down and taken off-line, costing a considerable amount of time and money while the turbine 36 is not operating. Many times, premature excessive wear of the gland sealing arrangement 44 causes excessive leakage between the turbine shaft 38 and the housing 40 to occur well before the time that the turbine 36 is regularly scheduled to be taken off-line for routine maintenance. Where this is the case, leakage between the shaft 38 and the turbine housing 40 causes cooler air from outside the turbine 36, e.g., ambient air, to enter the turbine 36, which not only decreases the pressure differential, it also causes thermal losses lowering steam temperature within the turbine 36. These pressure losses and thermal losses reduce the operating efficiency of the turbine 36, which in turn increases operating costs thereby reducing operating profits. Even where the gland sealing arrangement 44 is performing adequately, pressure or vacuum fluctuations within the turbine 36 that can occur at less than full load operating conditions can induce undesirable vibration in a condensing or condensate pump (not shown) of a turbine condenser (not shown) of the steam system of which the turbine 36 is part that can cause premature pump bearing failure.

A brush seal assembly 30 constructed in accordance with the present invention is externally mounted to the high temperature device 34 and provides a seal with the rotating shaft 32 of the device 34 during device operation that that reduces pressure losses and thermal losses by helping maintain a desired pressure differential between the device 34 and ambient outside of the device 34. Where mounted to a turbine 36, a brush seal assembly 30 constructed in accordance with the present invention is an externally mounted second sealing arrangement 46 that provides a redundant seal between an exteriorly disposed part of a turbine shaft 38 that extends outwardly from the turbine housing 40 and the housing 40. As is shown in FIG. 1, the exteriorly disposed part of the turbine shaft 38 extends from the turbine housing 40 to a bearing housing 41 of the turbine that is spaced a distance from the turbine housing 40.

Such a second sealing arrangement 46 provided by the brush seal assembly 30 advantageously helps maintain a desired pressure differential between the turbine 34 and ambient outside the turbine 34 that significantly reduces pressure losses thereby reducing thermal losses during turbine operation even when wear of the first sealing arrangement 42, e.g., gland sealing arrangement 44, is undesirably high. In addition, such a second sealing arrangement 46 provided by a brush seal assembly 30 constructed in accordance with the present invention advantageously reduces or dampens the magnitude of vacuum leakage or pressure fluctuations during turbine operation in a manner that reduces and preferably substantially prevents condensing or condensate pump vibration thereby extending pump bearing life.

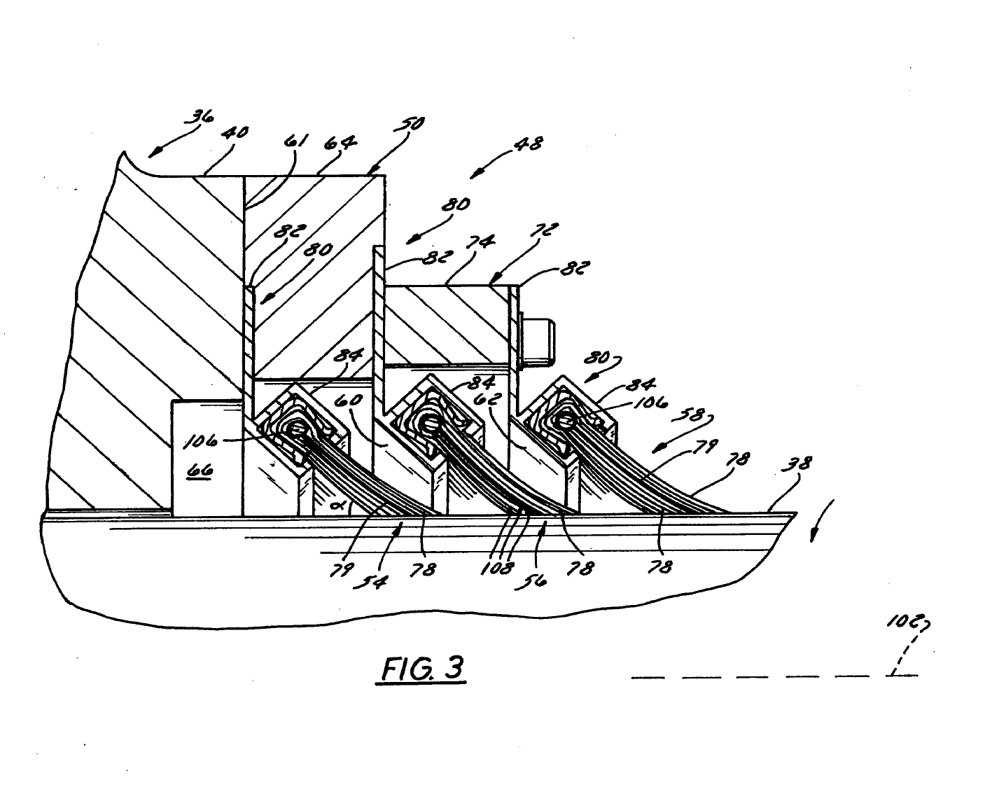

The brush seal assembly 30 includes a mounting arrangement 48 formed of an annular collar 50 that encircles the turbine shaft 38 and that is removably attached to the turbine housing 40 by a series of fasteners 52 that are spaced apart about the circumference of the collar 50. With additional reference to FIG. 3, the mounting arrangement 48 is configured to carry at least a plurality of annular brush seals 54, 56 and 58 that each extend about the outer periphery of the turbine shaft 38 and which can be axially spaced apart from one another. In the embodiment of the brush seal assembly 30 shown in FIG. 3, the mounting arrangement 48 carries a plurality of pairs, i.e., at least three, brush seals 54, 56 and 58 that each can be axially spaced apart from an adjacent brush seal in order to define a plurality of chambers 60 and 62 between adjacent pairs of brush seals 54 and 56 and 56 and 58 that can trap air therebetween in a manner that provides thermal insulation reducing thermal losses.

With continued reference to FIGS. 1 and 2, the collar 50 of the mounting arrangement 48 is an annular first or inner mounting ring 64 mounted to an axially extending face 61 of the turbine housing 36 by generally axially extending fasteners 52, such as bolts. Depending upon the configuration of the turbine housing 40, the ring 64 of the collar 50 can be of split ring construction, such as depicted in FIGS. 1 and 2, having one generally semicircular ring section 63 attached to another generally semicircular ring section 65, such as by using one or more radially extending fasteners 68 that each can be a bolt. Such a mounting arrangement construction can provide assembly adjustability including circumferential adjustability.

The collar 50 serves as a brush seal anchor to which at least a pair of brush seals 54 and 56 are releasably anchored. The collar 50 can also serve as a brush seal spacer to space apart the brush seals 54 and 56 in a manner that defines an insulating chamber 60 therebetween. The collar 50 can also locate the innermost brush seal 54 relative to an adjacent part of the turbine housing 40 in a manner that provides an insulating chamber 66 therebetween. Bolts 52 extend through bores in the collar 50 and can also extend through portions of one or more of the brush seals in fixing the collar 50 to a part of the turbine housing 40, such as axial face 61, e.g., mounting hub 70, or the like. Although not shown in the drawing figures, the mounting bolts 52 are received in threaded bores in the turbine housing 36. Bores in the collar 50 through which the bolts 52 extend can also be threaded if desired.

Where the assembly 30 includes more than a pair of brush seals, such as the three brush seal arrangement shown in FIG. 3, the mounting arrangement 48 includes an axially extending outermost brush seal mount 72 to which the third or outer brush seal 58 is removably mounted. The brush seal mount 72 can be fixed to the collar 50 in a manner that permits removal and which can allow additional brush seal mounts to be attached. As is shown in FIG. 3, the brush seal mount 72 is formed of an annular second or outer mounting ring 74 that is fixed by a plurality of fasteners 76, such as bolts, to the inner mounting ring 64.

With continued reference to FIG. 3, the mounting arrangement 48 is configured to orient at least the axially innermost brush seal 54 at an acute angle, α, with the turbine shaft 38 such that force acting upon the brush seal 54 resulting from the pressure differential between the turbine 36 and ambient urges the brush seal 54 toward the turbine shaft 38 enhancing sealing contact with the shaft 38. Mounting the brush seal 54 at an acute angle relative to the turbine shaft 32 produces an increased region of overlap between bristle-forming filaments 78 of the brush seal 54 and an adjacent part of the shaft 32 as a result of pressure-differential caused suction acting on the turbine side of the brush seal 54 pulling the brush seal 54 into tighter sealing contact against the shaft 32. As is also depicted by FIG. 3, each one of the brush seals 54, 56 and 58 can be acutely angled relative to the turbine shaft 32 with the mounting end of each brush seal 54, 56 and 58 disposed toward the turbine 36 and the sealing end of each brush seal 54, 56, and 58 facing away from the turbine housing 40 so that suction due to the pressure differential helps urge the sealing end of each brush seal 54, 56 and 58 into tighter sealing contact with the shaft 32.

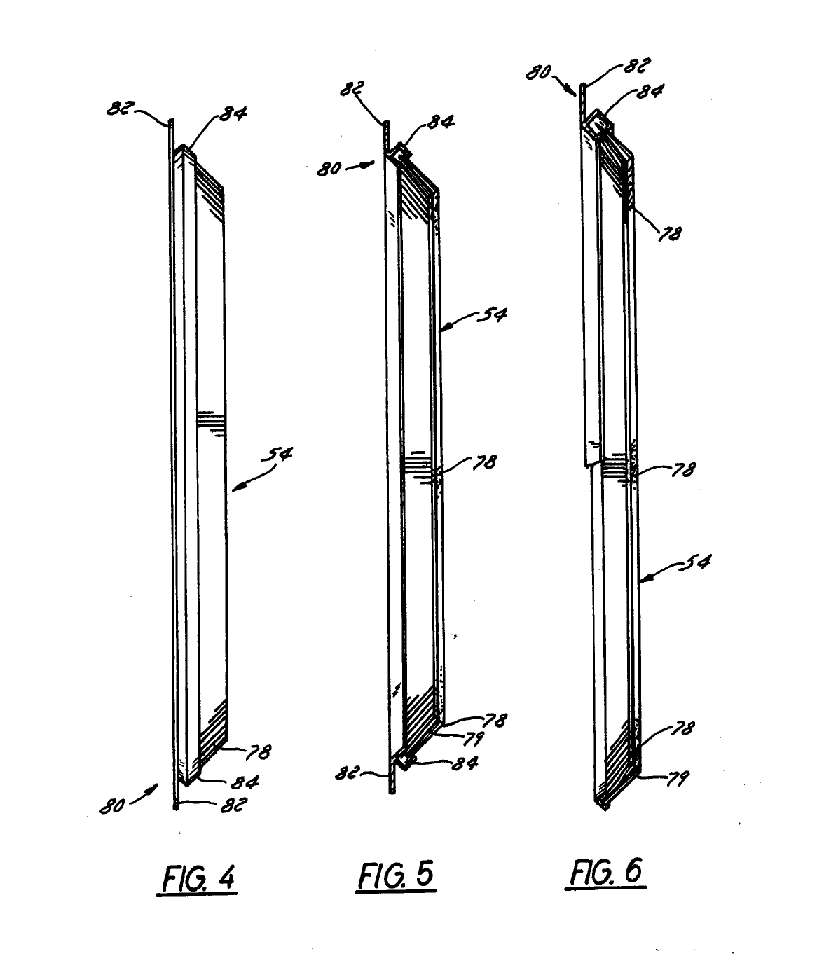

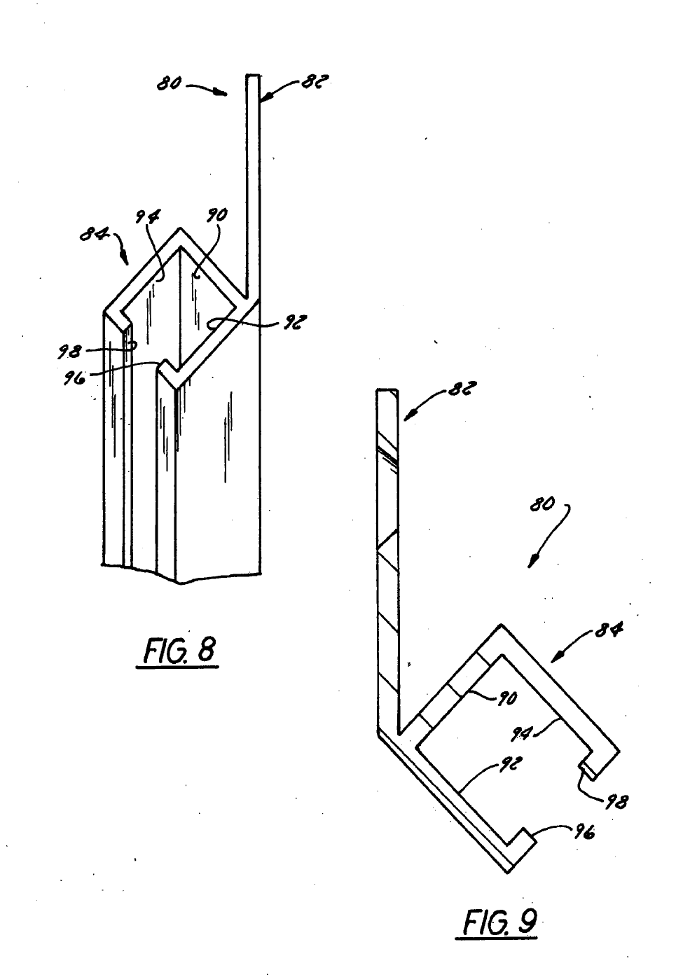

With additional reference to FIGS. 4-9, each brush seal 54, 56 and 58 is releasably received in a brush seal retaining bracket 80 that is removably attached to part of the mounting arrangement 48 and that is configured for releasably receiving and retaining a corresponding one of the brush seals 54, 56 and 58. Each brush seal retaining bracket 80 has a mounting flange 82 that can be elongate as shown from which extends a brush seal retainer channel 84 that slidably, telescopically receives a corresponding one of the brush seals 54, 56 and 58. Bolts, such as bolts 52 and/or bolts 76 can be used in mounting the flange 82 of each bracket 80 to a corresponding one of the mounting rings 64 and 74.

For example, bolts 76 can be used to directly attach the flange 84 of the brush seal retaining bracket 80 holding the outermost brush seal 58 directly to the outer mounting ring 74 of the mounting arrangement 48. Bolts 76 can be threadably engaged with the inner mounting ring 64 clamping the flange 84 of the bracket 80 holding intermediate brush seal 56 between rings 64 and 74. Bolts 52 used to attach the inner mounting ring 64 of the mounting arrangement 48 to the turbine housing 40 causes the ring 64 to clamp the flange 84 of the bracket 80 that holds the innermost brush seal 54 therebetween.

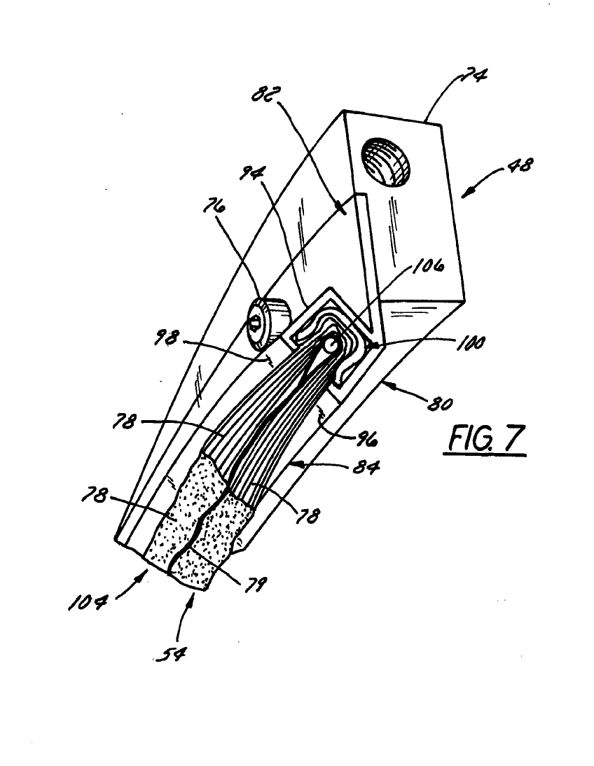

As is best shown in FIGS. 4-9, the brush seal retaining bracket 80 is curved and can be annularly shaped so as to form an annulus or ring that can be constructed of a plurality of brush seal retaining bracket sections 86 and 88 (FIG. 1) attached to part of corresponding mounting rings 64 and 74 of the mounting arrangement 48 end-to-end in a manner that endlessly encircles the turbine shaft 38. With reference to FIGS. 7-9, the brush seal retainer channel 84 includes a back wall 90 against which part of the mounting end, e.g., spine 100, of a brush seal, e.g., brush seal 54, received in the channel 84 is supported and can abut. Extending outwardly from the back wall 90 of the channel 84 are a pair of side walls 92 and 94 spaced apart far enough to accommodate the mounting end 100 of a brush seal 54, 56, or 58 received in the channel 84. For example, in one preferred embodiment, the channel side walls 92 and 94 are spaced apart by roughly the width of the mounting end of the brush seal and can be spaced apart to slidably and/or frictional the engage the sides of the brush seal mounting end to firmly support and engage a brush seal, e.g., brush seal 54, received in the channel 84. Each retainer channel sidewall 92 and 94 respectively has an inturned lip 96 and 98 at or adjacent its free end that can engage the mounting end 100 of a brush seal 54, 56 and 58 received in the channel 84 in a manner that prevents the brush seal 54 from being pulled out of the channel 84 during use and operation.

Such a mounting arrangement 48 advantageously permits removal of one or more of the brush seal retaining brackets 80 and mounting rings 64 and 74 as needed to remove and replace brush seals 54, 56 and/or 58 as needed during turbine operation. As a result of the modular construction of the mounting arrangement 48, as many of the brush seals 54, 56 and/or 58 that need replacement can be replaced while the turbine 38 is operating.

Although not shown in the drawing figures, the mounting arrangement 48 can and does preferably include a sealant between the inner ring 64 and the turbine housing 40 and another seal between the inner ring 64 and outer ring 74. Such a sealant can take the form of a sealant compound, such as an RTV sealant, silicone sealant or the like, and can also take the form of a gasket. If desired, the mounting flange 82 of one or more of the brush seal retaining brackets 80 can also be mounted with such a sealant disposed between one or both surfaces of the mounting flange 84 and an adjacent surface of the turbine housing 40 and/or rings 64 and/or 74. Use of such sealant produces a brush seal mounting arrangement 48 that is of substantially airtight construction even when it is used to mount a plurality of pairs of brush seals 54, 56 and 58 to a turbine 36.

In at least one embodiment, a brush seal assembly 30 constructed in accordance with the present invention has at least the innermost brush seal 54 acutely angled so that the pressure differential between the turbine 30 and ambient atmosphere outside the turbine 30 pulls the filaments 78 and/or a membrane 79 disposed within the filaments 78 into tighter sealing contact with the rotating turbine shaft 38. In one preferred embodiment, the angle, α, of at least the innermost brush seal 54 can vary between 15° and 60° with one preferred embodiment acutely angling the brush seal 54 about 45°. With regard to the brush seal assembly embodiment shown in FIG. 3, each one or the three brush seals 54, 56 and 58 is acutely angled at an angle of about 45° relative to a plane transverse or generally perpendicular to the rotational axis 102 of the turbine shaft 38 in a manner that causes the brush filaments 78 and/or membrane 79 to be pulled toward the turbine shaft 32 due to the pressure differential. Where a brush seal assembly constructed in accordance with the present invention employs a pair of brush seals, e.g., brush seals 54 and 56, each brush seal can be acutely angled, α, such as at an angle of between 40° and 60° and preferably about 45°.

In another embodiment that is not shown, each brush seal 54, 56 and 58 is angled at different acute angles. For example, in one embodiment, the innermost brush seal 54 is more acutely angled than the middle or intermediate brush seal 56 and the middle brush seal 56 is more acutely angled than the outer brush seal 58 with the outer brush seal 58 not being acutely angled if desired. For example, where the outer brush seal 58 is not acutely angled, it can be generally perpendicular or generally transverse to the axis of rotation of the turbine shaft 32. Where the brush seal assembly only has a pair of brush seals 54 and 56, one of the brush seals 54 can be inclined at a different angle than the other one of the brush seals 56.

As is best shown in FIG. 7, a suitable brush seal is a brush 104 that has brush bristle forming filaments 78 clamped or crimped around a core wire or rod 106 by a generally U-shaped spine 100 that is removably received in the seal retaining bracket channel 84 of brush seal retaining bracket 80. Nested within the filaments 79 is a relatively thin and flexible membrane 79 that is of imperforate construction that extends substantially the length of the brush 104. Filaments 78 on either side of the membrane 79 can support the flexible membrane 79 with the membrane 79 having a length substantially that of the filaments 78 or somewhat shorter.

The filaments 78 of at least one brush seal 54, 56 and/or 58 of the brush seal assembly 30 are made of a material that can wear in a manner that maintains the seal with the rotating turbine shaft 32 and which can actually improve seal performance as it wears when it rubs against the turbine shaft 32. In one preferred embodiment, such a filament material of the at least one brush seal 54, 56 and/or 58 is a polymeric material, such as nylon, e.g., nylon 6. In one preferred embodiment, the filament material of the at least one brush seal 54, 56 and/or 58 is a heat stabilized nylon. In a preferred brush seal embodiment, such polymeric brush seal filaments are made of an intumescing material, such as a heat stabilized nylon, having a linear coefficient of thermal expansion of at least 60 10⁻⁶ m/m per degree Kelvin. Where the at least one brush seal employs a membrane 79, the membrane 79 can be made of a rubber, ethylene propylene diene monomer or EPDM. As such, the life of a brush seal assembly 30 constructed in accordance with the present invention can be extended because sealing performance is maintained even while enduring significant brush wear. Brush seal assembly life is advantageously extended so that replacement of one or more of the brush seals 54, 56 and/or 56 can be done during regularly scheduled turbine downtime thereby optimizing efficient turbine operation.

Other suitable brush filament materials include polyphenylene sulfide (PPS) such as RYTON, polyether ether ketone (PEEK), polytetrafluoroethylene, such as TEFLON, KEVLAR, NOMEX, along with combinations thereof. Suitable membrane materials include a fluoroelastomer rubber or fluoroelastomer rubber polymer, such as VITON, FKM VITON, or FKM, polyether ether ketone (PEEK), and/or polytetrafluoroethylene, such as TEFLON.

With reference to the innermost brush seal 54 shown in FIG. 10 but applicable to all of the brush seals 54, 56 and 58 of the seal assembly 30, filaments 78 of at least the innermost brush seal 54 heat up as a result of high temperature operation of the turbine and friction due to contact between filaments 78 and the rotating turbine shaft 38. As a result, it is estimated filament temperatures reach at least 300° Fahrenheit and are believed to reach in excess of 350° Fahrenheit where filament contact occurs with the shaft 38. As a result of turbine shaft rotation ranging from between about 4,000 revolutions per minute and about 7,000 revolutions per minute, filaments 78 in contact with the shaft 38 are placed under a significant amount of tension in a direction generally perpendicular to the lengthwise direction of the brush seal 54.

Filaments 78 of at least one brush seal 54, 56 and/or 58 are composed of a polymeric material, nylon, which is not normally used for sealing applications in such high temperature environments. It has been discovered that such a polymeric material compensates for wear-related filament loss by viscoelastically creeping over time. Such viscoelastic creep results from the combination of heat and tensile stress placed on filaments 78 of the at least one brush seal 54, 56 and/or 58. As wear occurs, slight lengthening of filaments 78 over time due to creep compensates for wear and can even cause sealing to be enhanced in at least some instances.

In one preferred brush seal assembly 30, the filaments 78 of the innermost brush seal 54 is made of a metallic filament material of self-lubricating material that preferably has self-lubricating, e.g., lubricity, properties and either the intermediate brush seal 56 and/or or the outermost brush seal 58 are made of filaments 78 of intumescing construction. On such filament material is bronze that also enables the brush seal 54 to electrically ground the turbine shaft 38 and therefore serve as an electrical ground for the shaft 38. If desired, the filaments 78 of the innermost brush seal 54 can be formed of another metallic bearing material of self-lubricating composition having good wear resistance as it produces low friction contact with the shaft 38. If desired, the filaments 78 of the innermost brush seal 54 can include or be formed of copper or a copper alloy. In such a brush seal assembly, the filaments 78 of at least one of the intermediate brush seal 56 and outermost brush seal 80 are formed of intumescing material, such as preferably a heat stabilized nylon having a a linear coefficient of thermal expansion of at least 60 10⁻⁶m/m per degree Kelvin.

Sealing performance of the at least one brush seal constructed of a polymeric material is maintained for an extended period of time and can even be improved as a result. During operation, the free ends or tips of filaments 78 of such a brush seal 56 and/or 58 contacting the rotating turbine shaft 38 splay, degrade, deform, carbonize, and even can melt. Over time, filament length increases due to creep compensating for length loss due to wear. As a result of creep compensating for wear, the filament surface area of contact with the turbine shaft 38 can actually increase such that sealing performance is maintained despite wear. This is because effective filament length is substantially maintained due to creep despite wearing occurring.

In addition, wear that occurs while effective filament length is at least maintained in at least a majority of the filaments 78 of the at least one brush seal 56 and/or 58 can help maintain sealing due to wear changing the nature of contact between at least some of the worn filaments 78 and the turbine shaft 38. End splaying 108 (FIG. 3) of worn filaments 78 can cause the free ends or tips of filaments to split that can entrap air helping to locally improve sealing in the splayed region. Splaying can also increase contact surface area with the turbine shaft 38. Friction can also heat up portions of filaments 78 rubbing against the turbine shaft 38 causing deformation to occur that can be plastic in nature. Such deformation can cause portions of filaments at or adjacent filament tips to bend causing a lengthwise extending bent filament portion of such bent filaments to contact the turbine shaft 38 increasing contact surface area as a result. Friction and/or wear can also result in at least some filament ends contacting the turbine shaft 38 to become bulbous or mushroom 108 (FIG. 3) which can also increase contact surface area. As a result of such wear occurring in combination with creep lengthening filaments 78 over time, wear maintains or even increases sealing with the turbine shaft 38 while creep compensates for filament length loss caused by such wear thereby helping maintain filament effective length.

Filaments 78 can also be made of a material that not only viscoelastically creeps over time in a manner that compensates for wear, filaments 78 can be made of such a material that is also of intumescing construction such that expansion or lengthening of filaments 86 occurs as the filaments 78 of the at least one brush seal 56 and/or 58 heats up, helping to maintain an effective filament length. In another preferred embodiment, the filaments 78 of at least one brush seal 56 and/or 58 are made of an intumescing construction but which has a suitable viscoelastic creep such that filament expansion and lengthening that occurs during heating provides wear compensation that maintains seal performance.

Where a membrane 79 is used, the membrane 79 can be made of an elastomeric material that is flexible and imperforate to help provide an imperforate barrier nested within filaments 78 of one or more of the brush seals. One membrane material is a rubber, EPDM, which is relatively thin having a cross sectional thickness less than one quarter of the width of the brush portion of the brush seal. While such a material also suffers wear, viscoelastic creep can also advantageously cause it to stretch and plastically deform over time in response to being exposed to such high temperatures and tension during operation. While wear tends to cause portions of the membrane 79 to disintegrate, viscoelastic creep that occurs over time tends to compensate for wear by helping to maintain effective membrane length along with its beneficial impact on seal performance.

Where a membrane 79 is used, the membrane 79 can also be made of a material that not only viscoelastically creeps over time in a manner that compensates for wear, the membrane 79 can be made of such a material that is also of intumescing construction such that expansion or lengthening of the membrane 79 also occurs as the brush seal heats up helping to maintain an effective membrane length. In another preferred embodiment, the membrane 79 of at least one brush seal that is of intumescing construction but which has relatively low viscoelastic creep such that membrane expansion and lengthening that occurs during heating causes wear compensation that maintains seal performance.

With reference to FIG. 3, each one of the brush seals 54, 56 and 58 can be of substantially identical construction with a brush seal rotation sequence that replaces the innermost brush seal 54 once wear becomes too great with one of the other two brush seals 56 and 58. In one brush seal rotation sequence, one wear of the innermost brush seal 54 becomes too great; it is replaced by the middle brush seal 56 with the outer brush seal 58 movable to the middle or intermediate position if desired. Where the outer brush seal 58 is moved to the middle position, a new or replacement brush seal is placed in the middle brush seal position (brush seal 56) or the outermost brush seal position (brush seal 58).

In another preferred embodiment, the filaments 78 of the innermost brush seal 54 are of a high temperature construction and made of a material, such as bronze, copper or a stainless steel, e.g., SS 304 or SS 316, capable of withstanding continuous temperatures of greater than 350° Fahrenheit where the turbine is a steam turbine and greater than 600° Fahrenheit where the turbine is a gas turbine. Membrane 79 can also be of a high temperature construction and made of a material, such as a stainless steel sheet, capable of withstanding continuous temperatures of greater than 350° Fahrenheit where the turbine is a steam turbine and greater than 600° Fahrenheit where the turbine is a gas turbine.

In one brush assembly 30, the innermost brush seal 54 has a different construction than that of the rest of the brush seals 56 and/or 58. In such a brush seal assembly embodiment, the innermost brush seal 54 is comprised of a bronze material having filaments 78 of a bronze composition including a bronze composition that provides at least some self-lubricity that reduces friction and wear associated with friction. Filaments 78 having such a bronze composition provide high temperature resistance enabling use of the brush seal 54 on steam turbines and gas turbines. Membrane 79 can be made of a relatively thin and flexible metallic material, such as a stainless steel sheet, that is also of temperature resistant construction capable of both steam and gas turbine use. Such a brush seal construction is ductile and of low-abrasion construction that minimizes and preferably prevents turbine shaft wear and friction preventing shaft distortion thereby maintaining smooth and wobble-free turbine shaft rotation. Such a brush seal assembly embodiment can have the brush seals 56 and 58 disposed outwardly from the inner seal 54 with one or both seals 56 and 58 having filaments 78 of a polymeric composition, e.g., nylon, PPS, PEEK, and/or TEFLON, that can be of intumescing material and can have a membrane of elastomeric composition, e.g., EPDM, a fluoroelastomer rubber/fluoroelastomer rubber polymer, PEEK and/or TEFLON.

In such a brush seal assembly embodiment, mounting arrangement 48 can be configured so the spacing between at least the innermost brush seal 54 and intermediate or middle brush seal 56 is reduced to zero or nearly zero eliminating chamber 60. Elimination of the chamber 60 enables filaments 78 of the innermost brush seal 54 that are made of bronze, copper or stainless steel to provide structural support for polymeric filaments 78 of the adjacent intermediate or middle brush seal 56. If desired, the mounting arrangement 48 can also be modified to eliminate chamber 62 thereby enabling the filaments 78 of outermost brush seal 58 to support filaments of the intermediate brush seal 56 and vice versa.

Various alternatives are contemplated as being within the scope of the present invention. It is also to be understood that, although the foregoing description and drawings describe and illustrate in detail one or more preferred embodiments of the present invention, to those skilled in the art to which the present invention relates, the present disclosure will suggest many modifications and constructions, as well as widely differing embodiments and applications without thereby departing from the spirit and scope of the invention.

1. A high temperature device brush seal assembly comprising:
a plurality of brush seals; and
a mounting arrangement removably attaching the brush seals to a high temperature device in sealing contact with a rotary shaft of the high temperature device.

2. The brush seal assembly of claim 1 wherein at least one brush seal comprises a brush having brush bristles of wear compensating construction.

3. The brush seal assembly of claim 2 wherein brush bristles comprises elongate wire-like filaments comprised of a polymeric material.

4. The brush seal assembly of claim 2 wherein brush bristles comprises elongate wire-like filaments comprised of a polymeric material having a viscoelastic creep that increases the effective filament length over time providing bristle wear compensation.

5. The brush seal assembly of claim 4 wherein the filaments are comprised of nylon.

6. The brush seal assembly claim 4 further comprising an imperforate membrane disposed within the filaments.

7. The brush seal assembly of claim 6 wherein the imperforate membrane is comprised of a polymeric material having a viscoelastic creep that increases the effective membrane length over time providing bristle wear compensation.

8. The brush seal assembly of claim 7 wherein the imperforate membrane is comprised of EPDM.

9. The brush seal assembly of claim 6 wherein at least one of the brush seals are disposed at an angle relative to a pressure differential between the high temperature device and atmosphere exterior of the high temperature device whereby the pressure differential urges at least one of the brush seals against a shaft of the high temperature device.

10. The brush seal assembly of claim 9 wherein a plurality of the brush seals are disposed at an angle relative to a pressure differential between the high temperature device and atmosphere exterior of the high temperature device whereby the pressure differential urges at least one of the brush seals against the shaft of the high temperature device.

11. The brush seal assembly of claim 10 wherein each one of the brush seals are disposed at an angle relative to a pressure differential between the high temperature device and atmosphere exterior of the high temperature device whereby the pressure differential urges at least one of the brush seals against the shaft of the high temperature device.

12. The brush seal assembly of claim 4 wherein at least one of the brush seals are disposed at an acute angle relative to the outer surface of the shaft.

13. The seal assembly of claim 12 wherein a plurality of the brush seals are disposed at an acute angle relative to the outer surface of the shaft.

14. The brush seal assembly of claim 13 wherein each one of the brush seals are disposed at an acute angle relative to the outer surface of the shaft.

15. The brush seal assembly of claim 2 wherein at least one of the brush seals are disposed at an acute angle relative to a plane generally perpendicular to a rotational axis of the shaft.

16. The brush seal assembly of claim 15 wherein a plurality of the brush seals is disposed at an acute angle relative to a rotational axis of the shaft.

17. The brush seal assembly of claim 1 wherein the high temperature device comprises a gas or steam turbine and wherein the shaft comprises a rotary turbine shaft extending outwardly from a housing of the turbine.

18. The brush seal assembly of claim 17 wherein at least one of the brush seals has filaments defining a sealing end in contact with the shaft and a mounting end received in the mounting arrangement where the brush seal is angled such that the mounting end is closer to the turbine than the sealing end.

19. The brush seal assembly of claim 17 wherein the brush seal filaments of at least one of the plurality of brush seals are comprised of wear compensating material.

20. The brush seal assembly of claim 19 wherein the brush seal filaments of at least one of the plurality of brush seals is comprised of a filament material having a linear coefficient of thermal expansion of at least 60 10⁻⁶ m/m per degree Kelvin.

21. The brush seal assembly of claim 19 wherein the brush seal filaments of at least one of the plurality of brush seals are comprised of an intumescing material.

22. The brush seal assembly of claim 21 wherein the brush seal filaments of at least one of the plurality of brush seals are comprised of a nylon.

23. The brush seal assembly of claim 22 wherein the brush seal filaments of at least one of the plurality of brush seals are comprised of a heat stabilized nylon.

24. The turbine brush seal assembly of claim 20 wherein the brush seal filaments of at least one of the brushes are comprised of PPS or PEEK.

25. The brush seal assembly of claim 19 wherein a brush seal disposed closest to the turbine is comprised of bronze, a bronze material, or a self-lubricating material.

26. The brush seal assembly of claim 25 wherein the brush seal filaments are comprised of bronze, a bronze material, or a self-lubricating material.

27. A brush seal assembly comprising:
a brush seal mounting arrangement mounted to one of a steam turbine and gas turbine;
a plurality of annular brush seals that endlessly encircle a rotary turbine shaft; and
wherein the brush seal closest to a pressure differential between the interior of the turbine and the exterior of the turbine is mounted at an angle that causes the pressure differential to urge the brush seal into sealing contact with the rotary turbine shaft.

28. The brush seal assembly of claim 27 wherein each one of the brush seals are acutely angled relative to a plane perpendicular to a rotational axis of the turbine shaft in a manner that causes the pressure differential to urge each one of the brush seals into sealing contact with the turbine shaft.

29. The brush seal assembly of claim 28 comprising a plurality of pairs of brush seals carried by the mounting arrangement that are spaced apart defining a thermally insulating chamber between each adjacent pairs of spaced apart brush seals.

30. The brush seal assembly of claim 29 wherein the brush seal closest to the turbine is of comprises a turbine shaft electrical ground.

31. The brush seal assembly of claim 30 wherein brush wear of one of the plurality of brush seals facilitates sealing and the filaments are comprised of a material that increases effective filament length during operation.

32. The brush seal assembly of claim 31 wherein the brush filaments are constructed of a material that viscoelastically creeps over time to increase effective filament length in a manner that compensates for filament wear.

33. The brush seal assembly of claim 32 wherein the brush filaments at least one of the plurality of brush seals are constructed of an intumescing material that increases effective filament length in a manner that compensates for wear.
